(19) United States
(12) Patent Application Publication
(10) Pub. No.: US 2008/0063095 A1
(43) Pub. Date: Mar. 13, 2008

(54) Rate Control with Imperfect Feedback

(75) Inventor: Ali S. Khayrallah, Cary, NC (US)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 11/530,041

(22) Filed: Sep. 8, 2006

(51) Int. Cl. H04K 1/10

(52) U.S. Cl. 375/260

(57) ABSTRACT

A transmitting station divides an information block intended for a receiving station into a plurality of subsets and codes each subset of said information block at a different coding rate to obtain corresponding sets of coded bits for transmission to the receiving station. The coding rates for each subset are selected based on a channel quality estimate from the receiving station. The coding rates are related by the uncertainty in the channel quality estimate.

### TECHNICAL FIELD

The present invention relates generally to packet data transmission in a wireless communication system, and, more particularly, to a method of rate control for a high speed packet data channel.

### BACKGROUND

The wideband code division multiple access (WCDMA) standard includes a transmission method for high speed packet data services called High Speed Downlink Packet Access (HSDPA). HSDPA is an evolution of the downlink shared channel (DSCH) in prior versions of the WCDMA standard. HSDPA increases data throughput using enhancements such as fast scheduling, fast link adaptation, physical layer hybrid automatic repeat request (HARQ), and multi-code transmission. HSDPA takes advantage of the bursty nature of packet data to share the available resources among a plurality of users and thereby makes more efficient use of those resources.

HSDPA introduces a shared downlink channel called the High Speed Downlink Shared Channel (HS-DSCH). Transmissions on the HS-DSCH are divided into 2 ms time slots. Each mobile station measures the signal to noise ration (SNR) of the communication channel and reports channel conditions to the base station. A scheduler at the base station decides which mobile stations to schedule in each time slot based on the reported channel conditions, the amount of data pending in the buffer for each mobile station, and any quality of service guarantees. Up to fifteen channelization codes may be allocated to one or more mobile stations in each time slot. The base station identifies the mobile station(s) being scheduled, the code allocations, and the transmission format (i.e., modulation and encoding) on a downlink control channel called the High Speed Shared Control Channel (HS-SCCH). The transmission format is selected to achieve a desired reliability, for instance a desired block error rate (BLER) based on the channel conditions reported by the mobile station.

One problem in the system described above is the uncertainty in the channel conditions reported by the mobile station. Due to a noisy channel, there may be some error in the measurement of the signal-to-noise ratio. Additional errors may occur during transmission of the channel conditions to the base station. Further, there will typically be some delay between the time that the signal quality of the channel is measured and the time that a mobile station is scheduled to receive data on the HS-DSCH. For these reasons, the channel conditions reported by the mobile station may not accurately reflect the conditions of the channel at the time data is transmitted to a mobile station.

The reliability of the channel quality estimate is an important factor in the selection of the modulation and coding scheme. In general, a given modulation and coding scheme performs well over a narrow range in the SNR of the channel. If the channel conditions at the time of transmission vary significantly from what is reported by the mobile station, the modulation and coding schemes selected by the base station may not meet the desired performance criteria. If the channel conditions at the time of transmission are significantly worse than reported, a large number of transmission errors may occur. Conversely, if the channel conditions at the time of transmission are significantly better than reported, the capacity of the channel will be underutilized.

### SUMMARY

The present invention provides a method of selecting a transmission format (i.e., modulation and encoding) for the transmission of data from a transmitting station to a receiving station over a rate controlled channel. The present invention mitigates the uncertainty about the channel conditions reported by the mobile station by using a hierarchical coding scheme. The method involves dividing an information block into a plurality of subsets and encoding each subset at a different rate. The selected rates are related to an expected variation in the channel quality estimate provided by the mobile station. By relating the rates to an expected variation in the channel quality estimate, it can be ensured with high probability that at least one subset is correctly received by the receiving station.

The coded bits from the different subsets may be multiplexed together into a single stream before modulation and transmission. In other embodiments, the subsets may be segregated and transmitted over different channels. In a Time Division Multiple Access (TDMA) system, the coded bits for each subset may be transmitted in different time slots. In a Code Division Multiple Access (CDMA) system, the coded bits for each subset may be transmitted using a different spreading code. In an Orthogonal Frequency Division Multiplexing (OFDM) system, the coded bits for each subset may be transmitted on a different sub-carrier of an OFDM carrier. Also, combinations thereof are possible; for instance, allocation can be done on the basis of time slots and sub-carriers simultaneously.

As an alternative to coding subsets with separate error control codes and separate modulation schemes, it may be advantageous to encode and/or modulate the subsets together, while still providing different levels of protection. In an error control code with an unequal error protection feature, the subsets may be assigned to locations with different levels of reliability. Similarly, in a higher order modulation scheme, the subsets may be assigned to bits with different levels of reliability in the mapping from bits to constellation points. Similarly in a coded modulation scheme with an unequal error protection feature, the subsets may be assigned to locations with different levels of reliability.

### BRIEF DESCRIPTION OF THE DRAWINGS

FIG. 1 illustrates an exemplary wireless communication system.

FIG. 2 illustrates an exemplary transmitting station in a wireless communication system.

FIG. 3 illustrates an exemplary receiving station in a wireless communication system.

FIG. 4 illustrates an alternate embodiment of a transmitting station.

FIG. 5 illustrates an alternate embodiment of a receiving station.

FIG. 6 illustrates an exemplary procedure implemented by a transmitting station.

FIG. 7 illustrates an exemplary procedure implemented by a receiving station.

### DETAILED DESCRIPTION

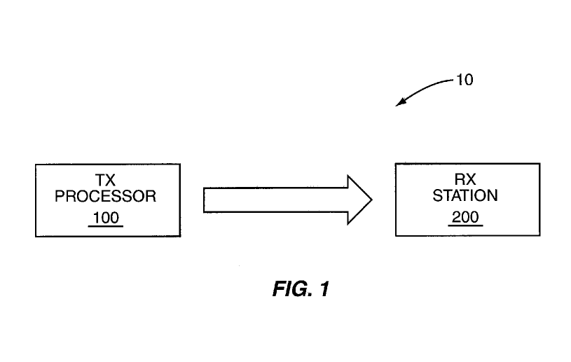

FIG. 1 illustrates a wireless communication system 10 including a transmitting station 100 and a receiving station 200. The transmitting station 100 may, for example, comprises a base station in a Wideband CDMA (WCDMA) network. The receiving station 200 may comprise a mobile station 200, such as a cellular telephone or other mobile device, operating in a WCDMA network. While the exemplary embodiment is described in the context of a WCDMA system, those skilled in the art should appreciate that the present invention may also be used in other communication systems, such as cdma2000, 1 xEV-DO, and WiMAX systems. Also, those skilled in the art should appreciate that the present invention may also be employed for uplink transmissions as well as downlink transmissions.

In the exemplary communication system 10, transmitting station 100 transmits packet data over a shared channel to a plurality of receiving stations 200. In WCDMA systems, the shared channel is known as the High Speed Downlink Shared Channel (HS-DSCH). The transmitting station 100 transmits packet data to one receiving station 200 at a time on the HS-DSCH. The receiving stations 200 measure the channel quality and send channel quality feedback to the transmitting station 100. In WCDMA systems, this feedback is in the form of a channel quality indicator (CQI). The CQI is determined by measuring the signal to noise ratio (SNR) at the receiving station 200 and using the measured SNR to select the CQI. The transmitting station 100 uses the channel quality feedback from the receiving stations 200 to schedule transmissions to the receiving stations 200 and to select a modulation and coding scheme (MCS), also referred to herein as the transmission format, to achieve a targeted performance criteria. For example, the MCS may be selected to achieve a desired block error rate (BLER).

The transmitting station 100 and receiving station 200 in WCDMA systems implement a hybrid automatic repeat request (HARQ) protocol. Data for transmission is divided into transport blocks. Each transport block is protected by a check code, such as a cyclic redundancy check (CRC) code. When block errors occur, receiving station 200 sends a negative acknowledgement (NAK) to transmitting station 100. The transmitting station 100 may retransmit the erroneous block. Alternatively, if incremental redundancy is used, transmitting station 100 may send complementary data.

One problem with the rate control mechanism described above is that the measured SNR used by the receiving station 100 to determine the CQI may not accurately reflect the SNR of the channel at the time of transmission. Part of the uncertainty is due to measurement and reporting errors caused by a noisy channel, and part of the uncertainty is due to the delay between the time the SNR is measured and the time that data is actually transmitted to the receiving station 200. This uncertainty can be reduced but never entirely eliminated. A small variation in the SNR may have a significant impact on the performance of the MCS. Therefore, the impact of error in the measured SNR needs to be considered. For instance, assume that the target BLER is 10%. For a given MCS, a small decrease in the SNR may drive the BLER as high as 50%. In this case, a large number of transport blocks will need to be retransmitted. In the worst case, the data buffers at the receiver and/or the transmitter would overflow, resulting in lost information, or a dropped connection. Conversely, a small increase in the SNR, may drive the BLER as low as 1%. In this case, the capacity of the channel will not be fully utilized, since an MCS with a higher payload could have been used instead.

The present invention mitigates the uncertainty about the channel conditions by using a hierarchical coding scheme. Broadly, the method involves dividing an information block into a plurality of subsets and coding each subset at different but related rates. The selected rates reflect the uncertainty in the channel quality estimate.

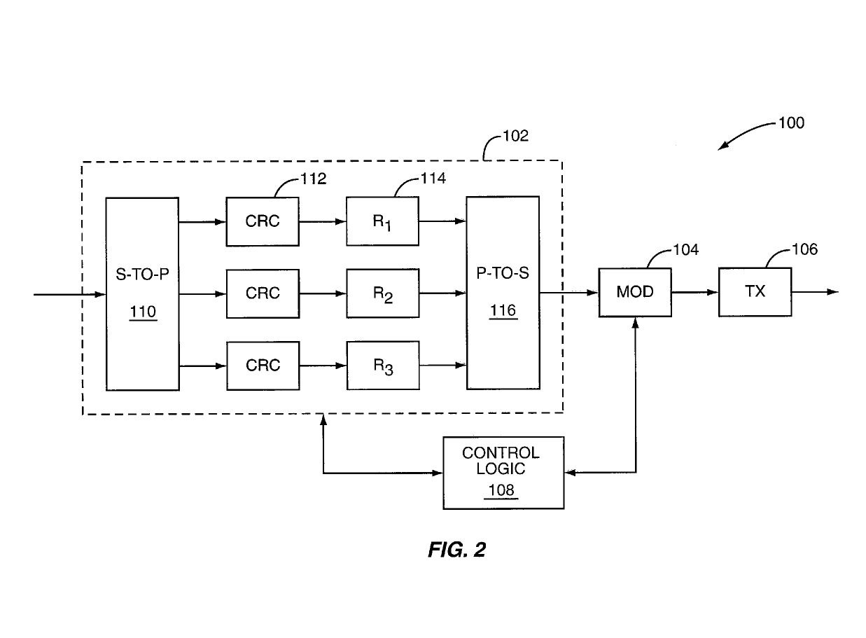

FIG. 2 illustrates an exemplary embodiment of a transmitting station 100 according to one embodiment of the present invention for a WCDMA system. Those skilled in the art will readily appreciate that other access technolgies can be used, such as cdma2000, 1 xEV-DO, and WiMAX systems. The transmitting station 100 comprises a coding circuit 102 to encode an information block for transmission, a modulator 104 to map coded bits to corresponding modulation symbols, a transmitter 106, and control logic 108 to control operation of the transmitting station 100. Coding circuit 102 encodes the information block for transmission as described in more detail below. Modulator 104 maps the coded bits output by the coding circuit 106 into corresponding modulation symbols. The modulator 104 may comprise, for example, an 8-PSK or 16 QAM modulator. Also, modulator 104 may implement a form of coded modulation in which different sets of the coded bits are allocated to different bits in the bitmap of the modulation constellation. Transmitter 106 transmits the modulation symbols to the receiving station 200. In the exemplary embodiment, the transmitter comprises a WCDMA transmitter. However, those skilled in the art will recognize that the transmitter 106 may comprise any type of transmitter including a TDMA transmitter, narrowband CDMA transmitter, or OFDM transmitter.

Coding circuit 102 comprises a serial to parallel (S-to-P) converter 110 to divide an input information block into three parallel subsets. Each subset is encoded by an inner encoder 112 and an outer encoder 114. Inner encoder 112 may comprise a cyclic redundancy check (CRC) encoder. Outer encoder 114 may comprise any type of error correction encoder, such as a convolutional encoder or block encoder. As explained below, the coding rate for the outer encoder 114 is different for each subset. The function of the outer encoder 114 is to allow correction of bit errors at the receiver that may occur during transmission. The inner encoder 112 enables the detection of decoding errors at the receiving station 200. A parallel to serial (P-to-S) converter 116 recombines the coded bits from each subset into a single coded bit stream for output to modulator 104. The P-to-S converter 116 may interleave the coded bits to make them more resistant to burst errors.

S-to-P converter 110 may divide the input bits equally between all subsets. In this case, the number of coded bits for each subset will be different. In other embodiments, S-to-P converter 110 may divide the input bits proportionally based on the coding rate for each subset. In this case, the number of information bits in each subset will be different, but the number of coded bits will be the same.

In operation, receiving station 200 estimates the signal-to-noise ratio (SNR) of the channel and provides channel quality feedback (e.g., CQI) to transmitting station 100. The coding rate Rₓ for each subset of the information block is selected based on channel quality feedback from the receiving station. Assuming three subsets, the coding rates for the subsets are denoted by R₁, R₂, and R₃. The coding rates R₁, R₂, and R₃ are related by R₁<R₂<R₃. Assume that R₂ is selected to provide a normal level of error protection that achieves the desired performance criteria (e.g., BLER) based on the measured SNR, which is denoted herein as Sₘ. For R₁, it is assumed that the actual SNR is less than Sₘ with a predicted variation of σ. Therefore, R₁ is selected to achieve the desired performance criteria at SNR S₁=Sₘ−σ. The coding rate R₁ provides a greater than normal level of protection. For R₃, it is assumed that the actual SNR is greater than Sₘ with a predicted variation of σ. Thus, R₃ is selected to achieve the desired performance criteria at SNR S₃=Sₘ+σ. The coding rate R₃ provides less than the normal level of protection. How is sigma calculated

At receiving station 200, the three subsets are decoded and the CRC for each subset is checked. If the actual SNR, denoted as Sᵣ, is less than S₁, then all three subsets will likely fail. If S₁≦Sᵣ<Sₘ, then the subset coded at rate R₁ will likely succeed while the subsets coded at rates R₂ and R₃ will likely fail. If Sₘ≦Sᵣ<S₃, then the subsets coded at rates R₁ and R₂ will likely succeed, while the subset of coded at rate R₃ will likely fail. If S₃≦Sᵣ, then all three subsets will likely succeed. By relating the expected variation σ to the uncertainty in the estimation of the SNR, it can be ensured that the subset coded at rate R₁ succeeds with high probability, which in turn insures that some data is received with minimal delay.

The expected variation a can be a predetermined value that is saved in memory and used to compute the coding rates. The value can be determined based on simulations or empirical data that is collected over a period of time. In other embodiments, the expected variation can be computed based on channel conditions at the time of transmission. For example, the presence of noise contributes to the difficulty in estimating channel conditions. The expected variation, therefore, could be computed based on the current noise level. The expected variation may be computed based on a predetermined formula. In other embodiments, the expected variation can be pre-computed for a plurality of noise levels and stored in a lookup table.

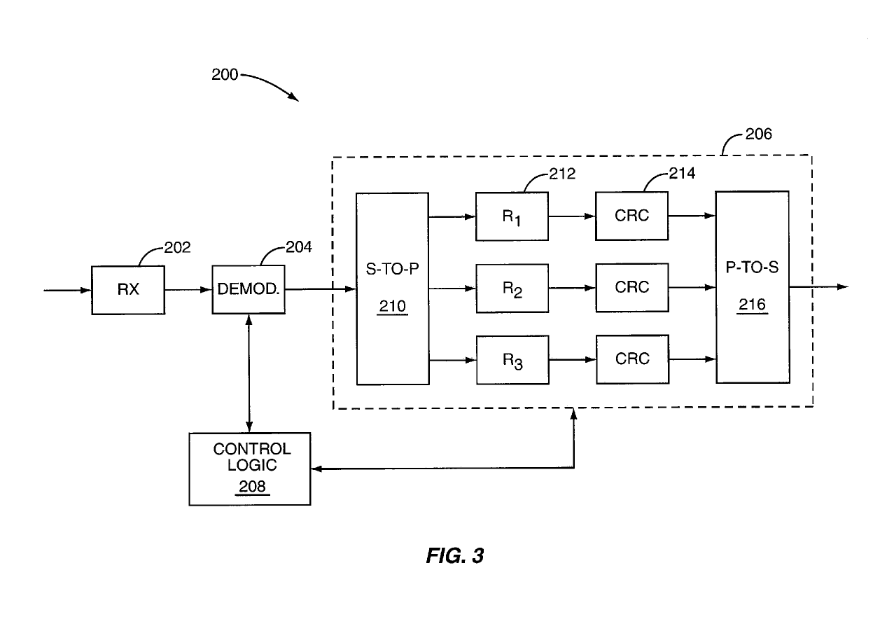

FIG. 3 illustrates an exemplary receiving station 200. The receiving station comprises a receiver 202, a demodulator 204, a decoding circuit 206, and control logic 208. The receiver 202 receives signals transmitted by the transmitting station 100. Receiver 202 may comprise a WCDMA receiver, a narrowband CDMA receiver, a TDMA receiver, an OFDM receiver, or other type of receiver. Demodulator 204 demodulates the received signal and supplies demodulated bits to the decoding circuit 206. Decoding circuit 206 decodes the demodulated bits and checks whether each subset is correctly received. If differential demodulation is being used, the demodulator 204 may use feedback from the decoding circuit 206 for demodulating the received signal. Control logic 208 controls operation of the receiving station 200.

Decoding circuit 206 comprises an S-to-P converter 210 to divide the demodulated bits into parallel subsets. Each subset is processed by an outer decoder 212 and inner decoder 214. The outer decoder 212 corrects bit errors that may have occurred during transmission. Outer decoder 212 may feedback information to the demodulator if differential modulation is being used. Inner decoder 214 checks whether the subsets are correctly received and generates an error signal when an error occurs. Control logic 208 reports errors to the transmitting station 100 by sending a NAK.

In some embodiments, the control logic 208 may report errors separately for each subset. Separate reporting for each subset, however, would effectively triple the amount of feedback for HARQ operation as compared to a conventional system. The amount of feedback for HARQ operation can be reduced by exploiting the properties of the transmission format. For example, the control logic 208 may check the CRC for each subset sequentially beginning with the subset having the greatest error protection and send a negative acknowledgement (NAK) for the first subset that fails the CRC check. If the subset with the greatest error protection fails, it may be assumed that the subsets with less protection will also fail and the receiving station 200 may quit checking the CRC. The failure of the less protected subsets is implied by the NAK of the most protected subset. If the subset with the greatest error protection succeeds, the next subset is checked. This process continues until a NAK is generated or until the last subset is reached. When a NAK is generated, it is implied that all less protected subsets also failed. It is also implied that subsets with greater error protection succeeded. By using the implied NAK for less protected subsets, only a single NAK needs to be sent to the transmitting station 100.

If the application is tolerant of some data loss, or uses a higher layer HARQ process, the CRC check may begin with the least protected subset. If the least protected subset succeeds, the receiving station 200 may assume that the subsets with greater protection will also succeed and stop checking. If the least protected subset fails, the receiving station 200 would then check the next subset. This process continues until the last subset is reached or until a subset succeeds.

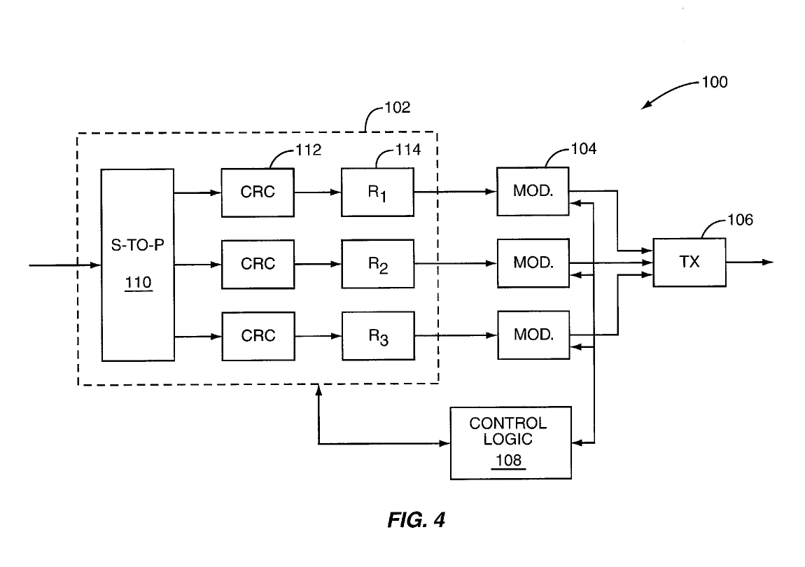

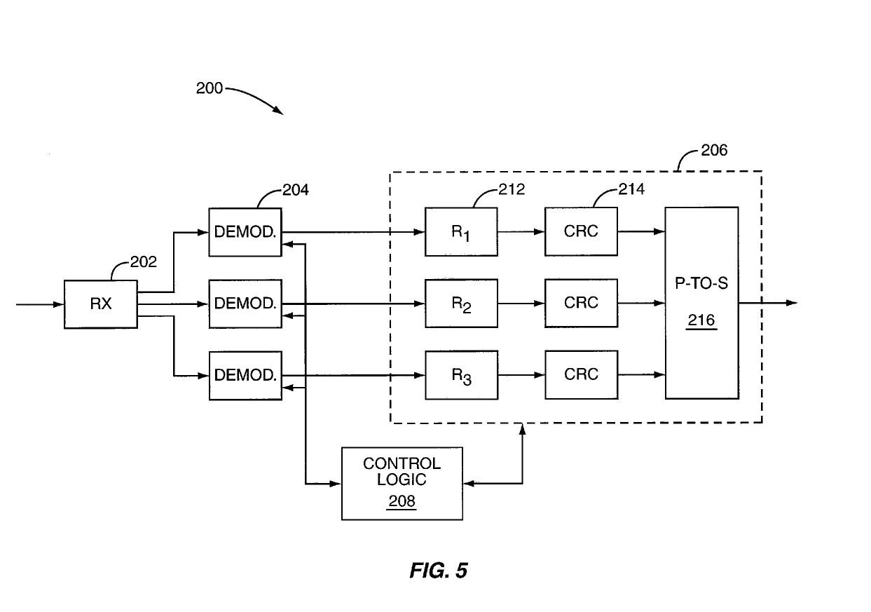

FIGS. 4 and 5 illustrate alternate embodiments of transmitting station 100 and receiving station 200, respectively. This embodiment is similar to the previous embodiments and the same reference numbers have been used to indicate similar elements. In the embodiments shown in FIGS. 4 and 5, the subsets of the information block are separately modulated and transmitted by transmitting station 100. The same modulation may be applied to each substream. Alternatively, different modulations may be used for different substreams. The use of different modulations for different substreams would be appropriate when the expected variation in the SNR is large. After modulation, the subsets are transmitted to receiving station 200 over different channels. If TDMA is used, the transmitter 106 may transmit each subset in a different time slot. In a CDMA system, the transmitter 106 may use different orthogonal spreading codes for each subset. In an OFDM system, the transmitter 106 may be sent on different subcarriers of the OFDM carrier.

The receiver 202 at the receiving station 200 receives and separates the transmitted signals. The separated signals are separately demodulated and decoded as previously described.

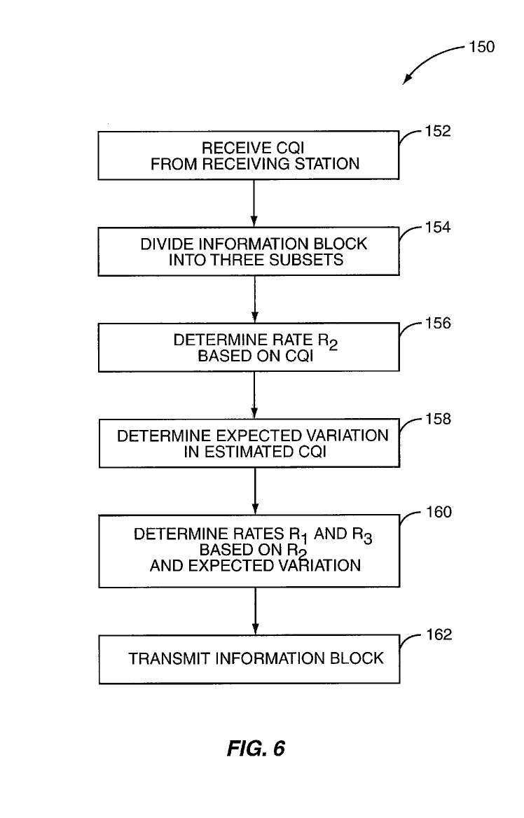

FIG. 6 illustrates an exemplary procedure 150 implemented by a transmitting station 100. In the following description, it is assumed that the transmitting station 100 is a base station in a mobile communication network, although the method can also be implemented in a mobile station. The transmitting station 100 receives a channel quality indication from the receiving station 200 (block 152). The transmitting station 100 divides an information block for the receiving station 200 into three subsets (block 154). The transmitting station 100 then determines the coding rates to use for each of the subsets of the information block (blocks 156-160). The transmitting station 100 determines a coding rate R₂ that provides a desired level of error protection assuming that the channel quality estimate is correct (block 156). Next, the transmitting station 100 determines an expected variation in the channel quality estimate provided by the receiving station 200 (block 158). Based on the expected variation in the channel quality estimate, the transmitting station 100 determines coding rates R₁ and R₃ based on the coding rate R₂ and the expected variation (block 160). The information block is then transmitted as previously described using code rates R₁, R₂, and R₃ for respective subsets of the information block (block 162).

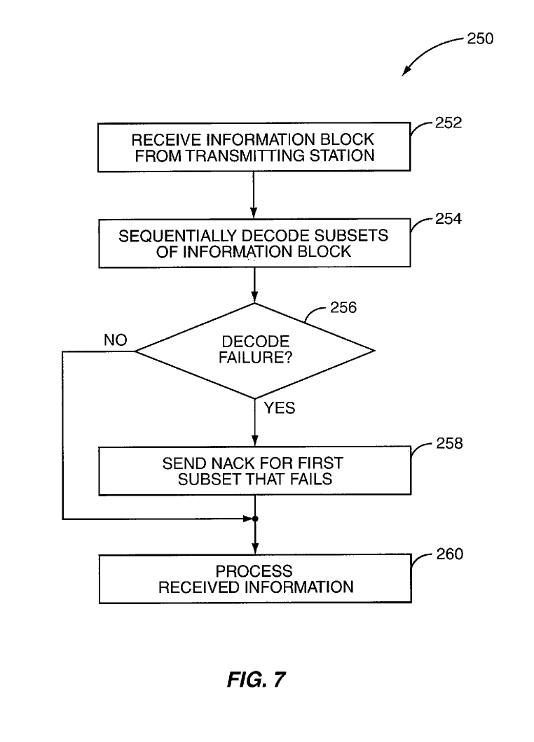

FIG. 7 illustrates an exemplary procedure 250 implemented by a receiving station 200 for decoding information blocks. The receiving station 200 receives the information block, which has been coded by the transmitting station 100 as previously described (block 252). The receiving station 200 sequentially decodes each subset of the information block (block 254). In this step of the process, the receiving station 200 may begin with either the most protected or least protected subset. Decoding continues until a decoding failure occurs (block 256). If a decoding failure occurs (block 256), the receiving station 200 sends a negative acknowledgement to the transmitting station 100 for the first subset that fails to decode successfully (block 258).

Thus far, the focus has been on embodiments of rate control. It is also possible to use the present invention in the alternative context of power control, or a mix of rate and power control. With power control, given the channel feedback, the transmitter chooses a power level (within some constraints set by the hardware limits and/or standards). In the baseline power control system, the transmitter also chooses an MCS that achieves the desired quality at the receiver given that power level. Again, given the uncertainty of the channel feedback information, in the present invention the transmitter splits the information into subsets, and proceeds as before.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of transmitting an information block to a receiving station, said method comprising:
receiving a channel quality estimate from a receiving station;
selecting a set of hierarchical coding rates providing different levels of error protection based on said channel quality estimate and an uncertainty in said channel quality estimate;
dividing an information block intended for the receiving station into a plurality of subsets;
coding each subset of said information block at a different one of said selected coding rates to obtain corresponding sets of coded bits; and
transmitting said coded bits to said receiving station.

2. The method of claim 1 wherein selecting the set of coding rates based on said channel quality estimate and the uncertainty in said channel quality estimate comprises selecting a first coding rate to provide a normal level of protection as determined based on said channel quality estimate, and a second coding rate providing a greater than normal level of protection to account for the uncertainty of said channel quality estimate.

3. The method of claim 2 wherein selecting the set of coding rates based on said channel quality estimate and the uncertainty in said channel quality estimate further comprises selecting a third coding rate providing less than the normal level of protection to account for the uncertainty of said channel quality estimate.

4. The method of claim 1 further comprising applying a cyclic redundancy check code to each set of coded bits.

5. The method of claim 1 wherein dividing the information block intended for the receiving station into a plurality of subsets comprises dividing said information block into approximately equal size subsets.

6. The method of claim 1 wherein dividing the information block intended for the receiving station into a plurality of subsets comprises dividing the information block into proportionally sized subsets based on said coding rates such that the sets of coded bits will be approximately equal in size.

7. The method of claim 1 further comprising combining said sets of coded bits into a single stream for transmission.

8. The method of claim 1 wherein each of said sets of coded bits are independently modulated.

9. The method of claim 8 wherein different sets of said coded bits are allocated to different bits in the bitmap of a coded modulation scheme.

10. The method of claim 8 wherein different sets of said coded bits are spread using different spreading codes.

11. The method of claim 8 wherein different sets of said coded bits are transmitted on different subcarriers in an OFDM system.

12. The method of claim 1 further comprising receiving an acknowledgement from said receiving station indicating whether a first one of said subsets was correctly received, and implying the status of a second subset from the acknowledgement of the first subset.

13. The method of claim 12 wherein the acknowledgement comprises a negative acknowledgement indicating an error in said first subset, and wherein an error in the reception of the first subset is implied from the negative acknowledgement.

14. An apparatus for transmitting an information block, said apparatus comprising:
control logic to select a set of hierarchical coding rates based on a channel quality indicator from a receiving station;
a coding circuit operative to divide said information block into a plurality of subsets, and to code each subset of said information block at a different one of said selected coding rates to obtain corresponding sets of coded bits; and
a transmitter to transmit said coded bits to said receiving station.

15. The apparatus of claim 14 wherein the control logic selects a first coding rate to provide a normal level of protection as determined based on said channel quality estimate, and a second coding rate providing a greater than normal level of protection to account for the uncertainty of said channel quality estimate.

16. The apparatus of claim 15 wherein the control logic further selects a third coding rate providing less than the normal level of protection to account for the uncertainty of said channel quality estimate.

17. The apparatus of claim 14 wherein the coding circuit applies a cyclic redundancy check code to each set of coded bits.

18. The apparatus of claim 14 wherein the coding circuit divides said information block into approximately equal size subsets.

19. The apparatus of claim 14 wherein the coding circuit divides the information block into proportionally sized subsets based on said coding rates such that the sets of coded bits will be approximately equal in size.

20. The apparatus of claim 14 further wherein the coding circuit combines said sets of coded bits into a single stream for transmission.

21. The apparatus of claim 14 wherein each of said sets of coded bits are independently modulated.

22. The apparatus of claim 21 wherein said transmitter allocates different bits in the bitmap of a coded modulation to different sets of said coded bits.

23. The apparatus of claim 21 wherein said transmitter transmits different sets of said coded bits using different spreading codes.

24. The apparatus of claim 21 wherein said transmitter transmits different sets of said coded bits are transmitted on different subcarriers in an OFDM system.

25. A transmitting station for transmitting an information block to a receiving station in a mobile communication network, said transmitting station comprising:
control logic to select a set of hierarchical coding rates based on a channel quality indicator from a receiving station;
a coding circuit operative to divide said information block into a plurality of subsets, and to code each subset of said information block at a different one of said selected coding rates to obtain corresponding sets of coded bits; and
a transmitter to transmit said coded bits to said receiving station.

26. The transmitting station of claim 25 wherein the transmitting station comprises a base station.

27. The transmitting station of claim 25 wherein the transmitting station comprises a mobile station.

28. A method of receiving an information block comprising two or more sets of coded bits encoded at different code rates, said method comprising:
decoding said sets of coded bits to produce corresponding sets of decoded information bits;
determining whether said sets of decoded information bits were correctly received;
sending an acknowledgment indicating whether a first of said sets of decoded information bits was correctly received; and
wherein said acknowledgement provides, by implication, an indication whether a second of said sets of decoded information bits was correctly received.

29. The method of claim 28 wherein the acknowledgment comprises a negative acknowledgement indicating an error in the reception of said first set of decoded information bits, and wherein an error in a second less protected set of decoded information bits is implied by said negative acknowledgment.

30. The method of claim 29 wherein determining whether said sets of decoded information bits were correctly received comprises performing error detection sequentially for each set of decoded information bits beginning with the most protected set.

31. The method of claim 30 further comprising stopping said error detection when an error is detected in one of said sets of decoded information bits.

32. The method of claim 29 wherein determining whether said sets of decoded information bits were correctly received comprises performing error detection sequentially for each set of decoded information bits beginning with the least protected set.

33. The method of claim 32 further comprising stopping said error detection when one of said sets of decoded information bits is correctly received.

34. An apparatus for receiving an information block comprising two or more sets of coded bits encoded at different code rates, said apparatus comprising:
a decoding circuit for decoding said sets of coded bits to produce corresponding sets of decode information bits, and for determining whether said sets of decoded information bits were correctly received;
control logic for sending an acknowledgment indicating whether a first of said sets of decoded information bits was correctly received; and
wherein said acknowledgement provides, by implication, an indication of whether a second of said sets of decoded information bits was correctly received.

35. The apparatus of claim 34 wherein the acknowledgment comprises a negative acknowledgement indicating an error in the reception of said first set of decoded information bits, and wherein an error in a second less protected set of decoded information bits is implied by said negative acknowledgment.

36. The apparatus of claim 35 wherein the decoding circuit sequentially detects errors in said sets of decoded information bits beginning with the most protected set.

37. The apparatus of claim 36 wherein said decoding circuit stops detecting errors when an error is detected in one of said sets of decoded information bits.

38. The apparatus of claim 35 wherein the decoding circuit sequentially detects errors in said sets of decoded information bits beginning with the least protected set.

39. The apparatus of claim 38 wherein the decoding circuit stops detecting errors when one of said sets of decoded information bits is correctly received.

40. A receiving station configured to receive an information block comprising two or more sets of coded bits encoded at different code rates, said receiving station comprising:
a decoding circuit for decoding said sets of coded bits to produce corresponding sets of decode information bits, and for determining whether said sets of decoded information bits were correctly received;
control logic for sending an acknowledgment indicating whether a first of said sets of decoded information bits was correctly received; and
wherein said acknowledgment provides, by implication, an indication of whether a second of said sets of decoded information bits was correctly received.

41. The receiving station of claim 40 wherein the receiving station comprises a mobile station.

42. The receiving station of claim 40 wherein the receiving station comprises base station.
